(19) United States
(12) Patent Application Publication
(10) Pub. No.: US 2009/0170555 A1
(43) Pub. Date: Jul. 2, 2009

(54) DYNAMIC MOBILITY MANAGEMENT SELECTION

(75) Inventors: Ulises Olvera-Hernandez, Kirkland (CA); Alan G. Carlton, Mineola, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/342,983

(22) Filed: Dec. 23, 2008

Related U.S. Application Data
(60) Provisional application No. 61/017,453, filed on Dec. 28, 2007.

(51) Int. Cl. H04M 1/00; H04B 1/38

(52) U.S. Cl. 455/552.1; 375/222

(57) ABSTRACT

A mobility service and control function (MSCF), operating in an application layer of a wireless transmit/receive unit (WTRU), selects and controls a plurality of mobility services. These mobility services may include session initiation protocol (SIP), Internet protocol (IP) Multimedia subsystem (IMS), voice call continuity (VCC), mobile IP (MIP), proxy MIP (PMIP), and generic access network (GAN), but are not limited thereto. The MSCF further selects and controls a plurality of air interface technologies for accessing a plurality of radio access networks. The MSCF allows application layer handling of mobility management.

### CROSS REFERENCE TO RELATED APPLICATION

This application claims the benefit of U.S. Provisional Application No. 61/017,453 filed on Dec. 28, 2007, which is incorporated herein by reference as if fully set forth.

### TECHNICAL FIELD

This application is related to wireless communications.

### BACKGROUND

Referring to FIG. 1, a representative tightly integrated mobility management (MM) network 100 includes a wireless transmit/receive unit (WTRU) 110 in communication with a Node-B 120 via an air interface. The Node-B 120 and a radio network controller 130 comprise a homogenous access of the wireless communication network 100. The homogenous access is depicted as a universal mobile telecommunication system (UMTS) compatible with the Third Generation Partnership Project (3GPP) Releases 5, 6, and 7. A serving general packet radio service (GPRS) support node (SGSN) 140 and a gateway GPRS support node (GGSN) 150 comprise a homogeneous core network 160 of the network 100. Multiple homogenous accesses communicate with a single homogenous core creating a centralized access network.

WTRU 110, shown in greater detail in FIG. 2, includes a platform 210, a multimode modem 220, and an application subsystem 230. The platform 210 includes baseband processing, support for peripherals such as a display, various inputs including voice, and various outputs. The multimode modem 220 includes radio frequency (RF) processing for air interface communication. The application subsystem 230 includes higher layer functionality (that is, layer 3 and above) and processing allowing the WTRU 110 to run various applications.

Mobility management functions of WTRU 110 are tightly controlled and implemented by the platform 210 and the multimode modem 220. In other words, intra-network handover from one homogeneous access to another is handled by the platform 210 and multimode modem 220.

This tightly controlled mobility handling of WTRUs has evolved in the developing 3GPP Long Term Evolution (LTE) networks. While LTE based networks have yet to be realized, these networks are evolving towards an all Internet protocol (IP) network in which mobility is greatly improved. FIG. 3 shows an LTE based wireless communication network 300 including a WTRU 310, an enhanced Node-B (eNode-B) 320, an IEEE 802 compliant access point (AP) 330, a mobility management entity (MME) 340, a packet data gateway (PDG) 350, and a packet data network (PDN) gateway 360. The heterogeneous access networks (LTE enhanced Node-B 320 and IEEE 802 compliant AP 330) are coupled with heterogeneous core networks (MME 340 and PDG 350). The heterogeneous access networks are involved local mobility, while the heterogeneous core networks are coupled to many eNode-Bs 320 and APs 330 and are involved in global mobility.

LTE compliant WTRU 310, as shown in FIG. 4, includes a platform 410, a multimode modem 420, and an application subsystem 430. Mobility management functions are handled higher in the protocol stack in the LTE compliant WTRU 310. Mobility is handled using air interface technology specific support from the multimode modem 420, such as System Information and System Capabilities, for example, and the application subsystem 430.

WTRU 310 utilizes a variety of solutions that address mobility in a heterogeneous environment at different levels. These solutions are predefined or preconfigured and their mobility functions are tightly integrated to the access networks supported by the various interface technologies of the multimode modem 420. The IEEE 802.21 media independent handover (MIH) services provide a handover/policy function that controls inter-technology handover. This type of handover/policy function is designed to address a specific set of air interface technologies and associated access networks, and to provide access network independent information, triggers, and notification services to identify the presence of an air interface technology and associated access network. Generic Access Network (GAN), also known as Universal Mobility Access (UMA), addresses heterogeneous networks at the access level by integrating IEEE 802 wireless local area networks (WLANs) through an interworking function that is tightly integrated with the global system for mobile communications (GSM) enhanced date rates for GSM evolution (EDGE) radio access network (GERAN). Voice Call Continuity (VCC) addresses the problem at the application level, however VCC is still tightly integrated within the 3GPP core network as shown in FIG. 1, relying on 3GPP standardized procedures, and therefore not truly heterogeneous (that is, access network independent).

Mobile IP (MIP) is another technology that supports mobility management at the application level and is access agnostic. However, MIP is unaware and unconcerned with the underlying condition of the supporting access network. As a result, seamless mobility cannot be supported only using MIP procedures.

Accordingly, a mobility technology is desired that would allow true heterogeneous mobility thereby allowing a WTRU to select mobility technologies and their associated mechanisms just as the WTRU selects any other service available to the user.

### SUMMARY

A mobility service and control function (MSCF), operating in an application layer of a wireless transmit/receive unit (WTRU), selects and controls a plurality of mobility services. These mobility services may include session initiation protocol (SIP), Internet protocol (IP) Multimedia subsystem (IMS), voice call continuity (VCC), mobile IP (MIP), proxy MIP (PMIP), and generic access network (GAN), but are not limited thereto. The MSCF further selects and controls a plurality of air interface technologies for accessing a plurality of radio access networks. The MSCF allows application layer handling of mobility management.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is a wireless communication network compliant with 3GPP Release 5, 6, or 7 standards;

FIG. 2 is a block diagram of a WTRU operating in the 3GPP Release 5, 6, or 7 wireless communication network of FIG. 1;

FIG. 3 is a wireless communication network compliant with LTE standards;

FIG. 4 is a block diagram of a WTRU operating in the LTE wireless communication network of FIG. 3;

FIG. 5 is a detailed block diagram of a WTRU including a mobility selection and control function as disclosed herein;

FIG. 6 is an IP multimedia service (IMS) based wireless communication system;

FIG. 7 is a block diagram of a WTRU operating in the IMS of FIG. 6;

FIG. 8 is a block diagram of a network having geographically overlapping E-UTRAN, GERAN, and UTRAN access networks; and

FIG. 9 is a signal flow diagram of a circuit switched fallback procedure including a mobility selection and control function as disclosed herein.

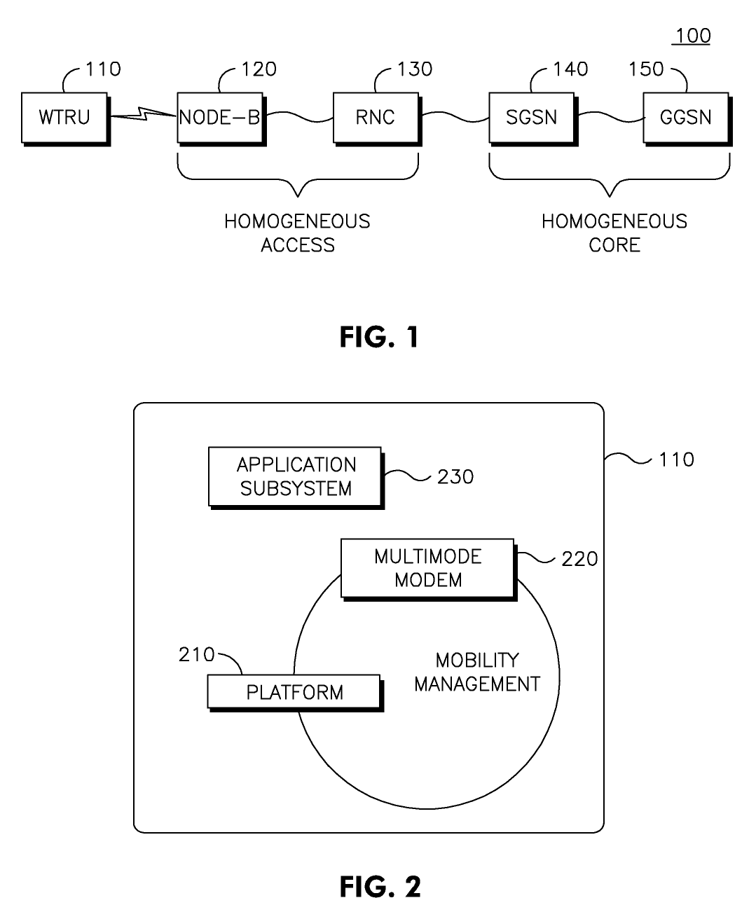

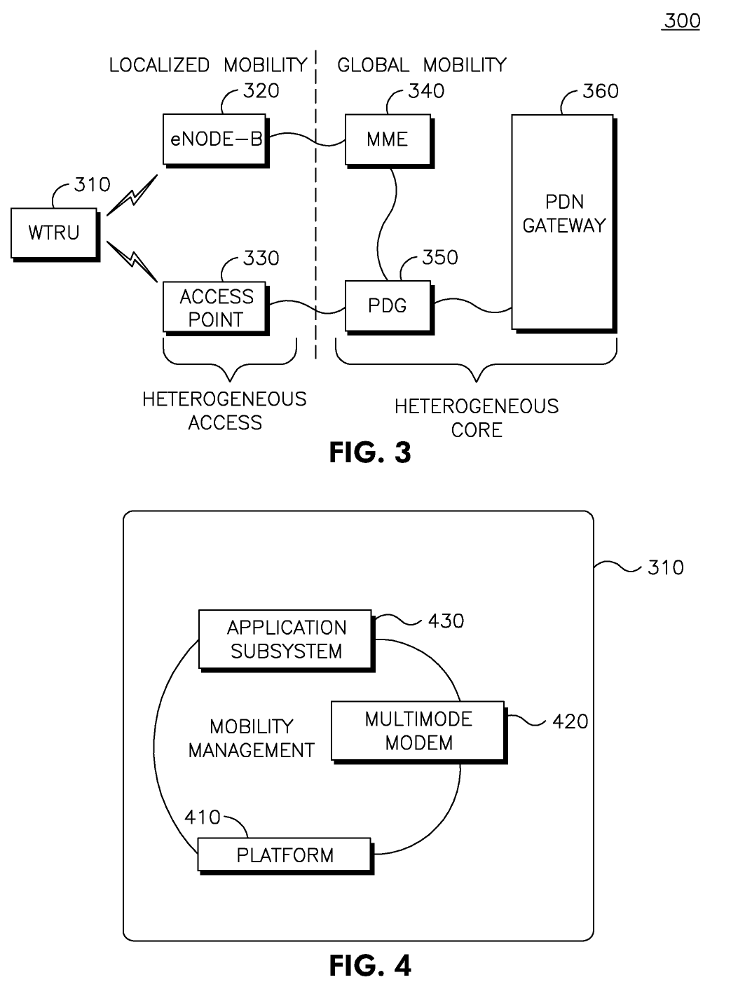

### DETAILED DESCRIPTION OF THE EMBODIMENTS

When referred to herein, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, a station (STA) or any other type of user device capable of operating in a wireless environment. When referred to herein, the terminology “base station” includes but is not limited to a Node-B, a site controller, an access point (AP), or any other type of interfacing device capable of operating in a wireless environment.

As represented in FIGS. 2 and 4, mobility management functionality in WTRUs is moving up the protocol stack. As a result, rather than designing another technology that would operate at lower layers (such as MIP, GAN, and the like as discussed above), a mobility management function operating at a higher layer in the protocol stack of a WTRU that utilizes existing and future mobility management protocols is an optimal solution.

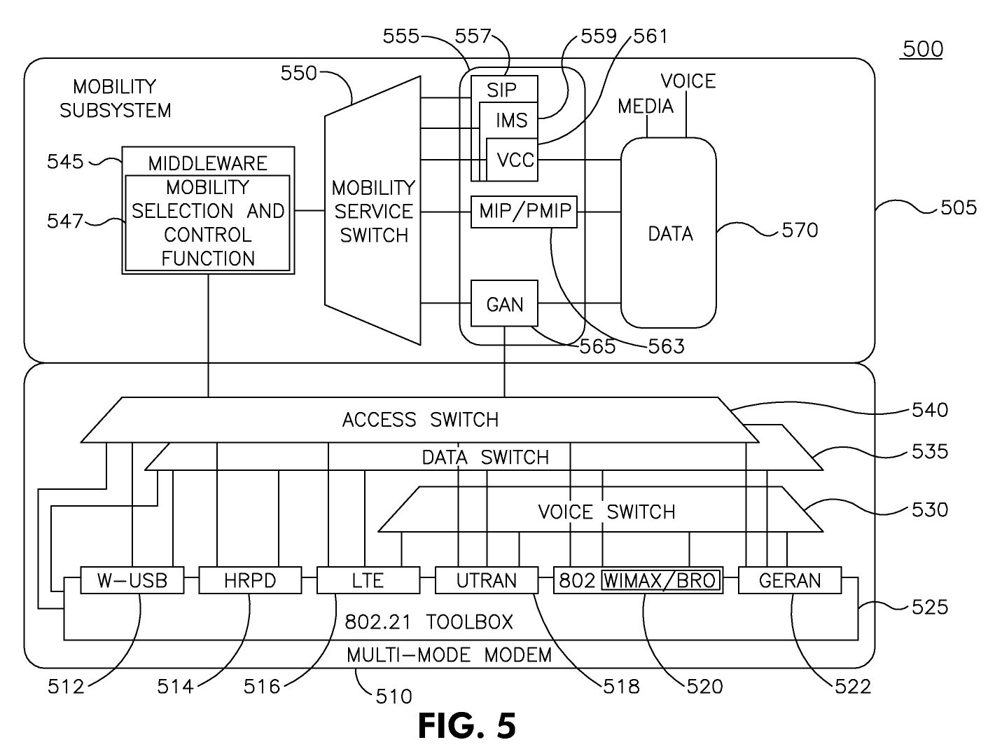

Referring to FIG. 5, a WTRU 500 includes a mobility subsystem 505 and a multimode modem 510. The WTRU 500 is capable of accessing a variety of lower layer air interface technologies via the multimode modem 510. WTRU 500 includes a wireless universal serial bus (W-USB) modem 512, a high rate packet data (HRPD) modem 514, an LTE modem 516, a UMTS terrestrial radio access network (UTRAN) modem 518, and IEEE 802 modem (such as, for example, an 802.11xx or 802.16 modem) 520, and a GERAN modem 522. It is noted that multimode modem may include other functionality as desired and the various technology specific modems depicted in FIG. 5 is not meant to be limiting. An IEEE 802.21 toolbox 525 provides MIH services (for example, MIH command, event, and/or information services) to the variety of air interface technologies. A voice switch 530 couples voice services from higher layers to the LTE modem 516, the UTRAN modem 518, the IEEE 802 modem 520, and the GERAN modem 522. A data switch 535 couples data service from higher layers to all of the variety of air interface technologies. It is noted that voice over IP (VoIP) services could be switched over the data switch 535. An access switch 540 couples the IEEE 802.21 toolbox 525 and the data switch 535 with higher layers services. The access switch 540 may be considered a service access point (SAP) coupling lower layer air interface technologies with the MSCF 547. It is noted that multiple air interface technologies may be selected simultaneously by the access switch 540.

The mobility subsystem 505 of the WTRU 500 includes higher layer middleware 545 that includes a mobility selection and control function (MSCF) 547. The MSCF 547 accesses the multimode modem 510 via the access switch 540. A mobility service switch 550 couples the MSCF 547 with a variety of mobility services 555. By way of example, mobility services 555 may include session management technologies such as session initiation protocol (SIP) 557, IMS 559, voice call continuity (VCC) 561, as well as other services including Mobile IP (MIP)/proxy MIP (PMIP) 563, and GAN 565. Data, including voice and other media, is provided via the data unit 570.

The architecture of WTRU 500 includes a higher layer MSCF 547 that provides management and coordination of the lower layer air interface technologies as well as the various other mobility services implemented in the WTRU 500 (that is, SIP 557, IMS 559, VCC 561, MIP/PMIP 563, GAN 565, and so on). The MSCF 547 may operate with or without end user interaction. For example, a user interface may be provided wherein the end-user defines a mobility profile. Alternatively, no user interface is provided and a default profile may be applied. The default profile could be actively updates via one of the plurality of air interface technologies provided in the multimode modem 510.

The MSCF 547 includes functionality for the selection and optimization of parameters within a particular technology or combination of technologies. The MSCF 547 further includes functionality for selecting an optimum air interface technology for a particular scenario and managing transitions among various mobility services in response to changing scenarios (for example, changing from GAN to IMS, GAN to LTE, and the like).

The MSCF 547 is capable of detecting and/or discovering the existence of candidate air interface technologies as well as mobility management services (that is, mobility services). The IEEE 802.21 toolbox 525 may assist the MSCF 547 in detecting and/or discovering candidate air interfaces and mobility services by way of MIH event, command, and information services. Additionally, WTRU 500 may be equipped with advanced radio technologies such as cognitive radios and software defined radio (SDR) that assists the MSCF 547 in detection and discovery. The MSCF 547 may be configured to evaluate various detected and/or discovered candidate air interface technologies and mobility services and determine which are the most suitable to a user. For example, the MSCF 547 may determine which technology is the most suitable based on user defined parameters stored in the WTRU or characteristics of the access network or core network to select mobility services that are appropriate for a given scenario. An associated NodeB, eNodeB, or AP identifier, a system operator code, or a geographical location are examples of identifiers that may be used to select an appropriate mobility service. Once the MSCF 547 determines that a particular mobility service or a collection of them will be selected, the MSCF 547 accesses that mobility service or services via the mobility service switch 550.

The mobility services 555 may be any mobility technology that is capable of handling mobility in a heterogeneous access environment. While WTRU 500 includes support for SIP 557, IMS 559, VCC 561, MIP/PMIP 563, and GAN 565, these are exemplary and any current or future heterogeneous mobility service may be used by the MSCF 547. These mobility services 555 may be accessed independently or in combination with one another. It is noted that since these mobility services reside at the application level, they are transported over data bearers in the selected air interface technology.

The MSCF 547 selects and controls a mobility service 555 and a lower layer air interface technology (such as W-USB 512, HRPD 514, LTE 516, UTRAN 518, IEEE 802 520, and GERAN 522) that is capable of carrying the mobility service 555 independently via the mobility service switch 550 and the access switch 540, respectively. For every mobility service 555 that is selected, the MSCF 547 may select one or many lower layer air interface technologies for carrying the selected mobility service 555. Of course certain mobility services 555, such as GAN 565, require specific air interface technologies. In such a case, the GAN function 565 may select the appropriate air interface technology. It is noted that this example is not limiting, and various other mobility services 555 may only be compatible with a subset of the supported air interface technologies.

The MSCF 547 processes information regarding mobility services and air interface technologies and associated access networks. This information may be provided through various means, such as MIH services, database queries, push/pull mechanisms, and the like. In contrast to traditional mobility solutions that operate on the basis of a handover/mobility policy or pre-defined criteria, the MSCF 547 provides dynamic, on-demand real-time access to a multiplicity of mobility services (or combinations of mobility services) housed at the application level. The MSCF selects a mobility service (or combination) based on the specific characteristics of the surrounding air interface technologies and associated access networks and supported mobility services, and user and operator preferences.

For example, to illustrate the dynamic selection of mobility services and air interface technologies and associated access networks by the MSCF 547, consider a scenario where WTRU 500 is currently associated with a GAN capable access network that is also MIP capable. The MSCF 547 discovers neighbouring air interface technologies and associated access networks as well as mobility services supported by these access networks by way of the methods described above. In the case where the neighbouring access networks support MIP only, the MSCF 547 may dynamically select the activation of MIP services to handle mobility requirements across the current and neighbouring networks.

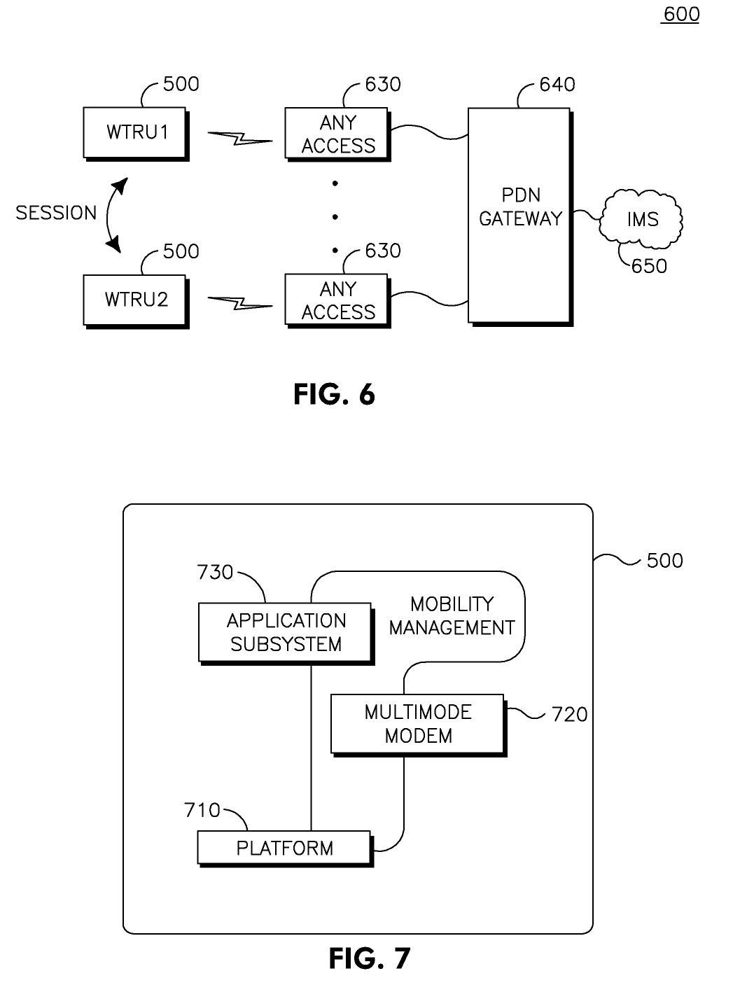

Referring to FIG. 6, an evolved wireless communication network 600 includes a plurality of WTRUs, including at least WTRU1 610 and WTRU2 620 that each includes a MSCF 547 as described above. The evolved network 600 also includes a plurality of access networks 630 that may be any type of access network, a PDN gateway 640, and an IMS core 650. The evolved network 600 is heterogeneous in that any access network 630 communicates with a PDN gateway 640 and an IMS core 650 allowing WTRU 1 610 transparent access using any access network 630.

WTRU1 610, shown in greater detail in FIG. 7, includes a platform 710, a multimode modem 720, and an application subsystem 730. Mobility management functions are handled in the application subsystem 730, where the MSCF 547 is resident in middleware. By fully porting mobility management selection and control to the application subsystem 730 by way of the MSCF 547, it is possible to evolve to a mobility environment where a session can be ported from WTRU1 610 to WTRU2 620 based on each WTRU's capabilities and the requirements of the session.

For example, referring back to FIG. 6, if a session is active on WTRU1 610, that happens to be a small-screen device, it may be desirable to port the session to WTRU2 620, that happens to be a large-screen device (such as, for example, a laptop). This may be the case even if the data rates supported by WTRU1 610 are suitable for the type of application that is running, or if channel conditions experienced by WTRU1 610 are acceptable. Thus the session, as opposed to the device, can be moved so that a user may take advantage of the availability of a large screen. The MSCF 547 allows selective utilization of various mobility services thereby providing a path that smoothly leads to an environment in which mobility is handled only at a session level.

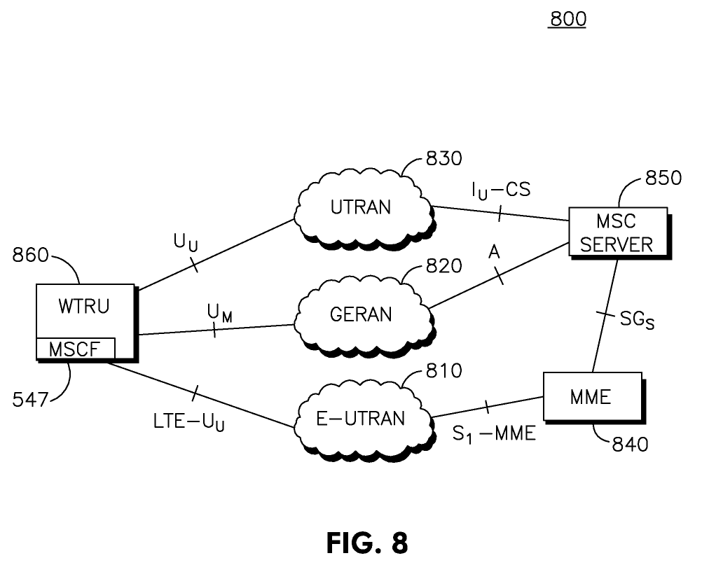

Another scenario in which the MSCF 547 may be advantageous is a circuit switched (CS) fallback scenario. Referring to FIG. 8, a network 800 includes geographically overlapping evolved UTRAN (E-UTRAN) 810, GERAN 820, and UTRAN 830 radio access networks. A mobility management entity (MME) 840 couples the E-UTRAN 810 with a mobile switching center (MSC) server 850. GERAN 820 and UTRAN 830 interface with the MSC Server 850 via CS interfaces A and Iu-CS, respectively. WTRU 860 includes a MSCF 547 as described above. WTRU 800, when connected to E-UTRAN 810, may use GERAN 820 or UTRAN 830 to establish one or more CS-domain services.

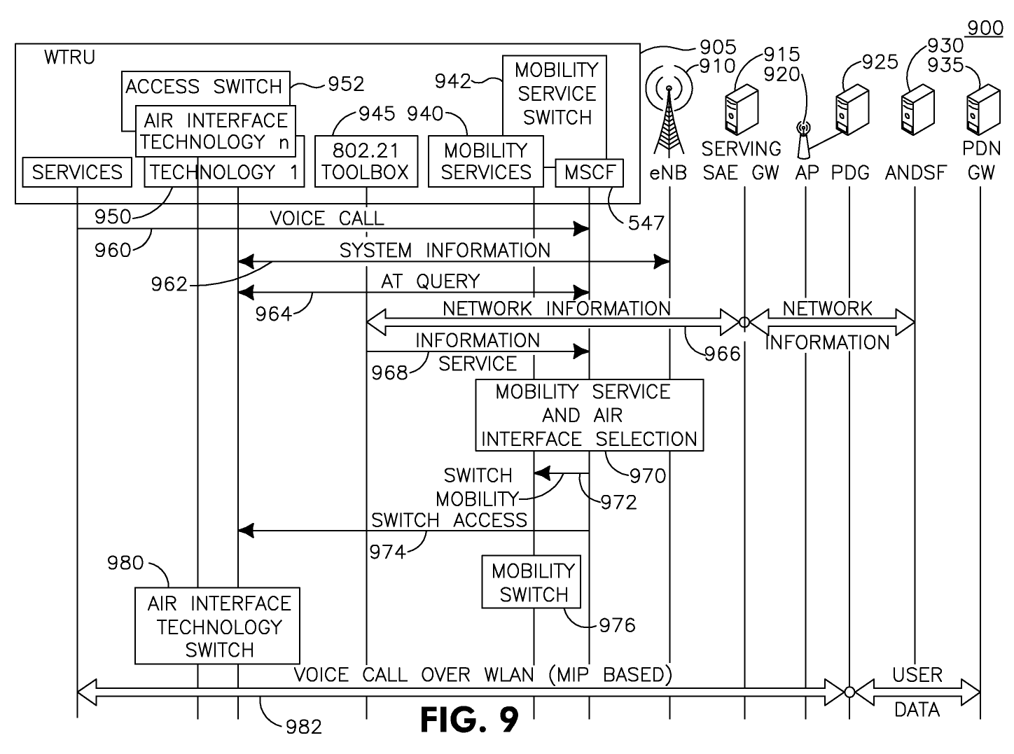

Referring to FIG. 9, a signal flow diagram of a CS fallback scenario 900 includes WTRU 905, an eNodeB 910, a serving system architecture evolution (SAE) gateway 915, an AP 920, aPDG 925, an access network discovery and selection function (ANDSF) 930, and a PDN gateway 935. The WTRU 905 includes a MSCF 547 as described above, a plurality of mobility services 940, a mobility services switch 942, an IEEE 802.21 toolbox 945, a plurality of lower layer air interface technologies 950, an access switch 952, a service unit 955 for receiving services provided to the WTRU 905.

The CS fallback procedure begins with WTRU 905 camped on an E-UTRAN cell and in a packet switched mode of operation. A voice call is in initiated (either WTRU originating or terminating) and an indication is received at MSCF 547 (step 960). An air interface technology receives system information from eNodeB 910, (step 962). MSCF 547 queries the air interface technology regarding the system information received in step 962 (step 964).

The 802.21 toolbox 945 may retrieve network information from ANDSF 930 via the serving SAE gateway 915 (step 966). This network information may include IMS Registration restriction information, available air interface technologies, quality of service (QoS) parameters, and the like. The 802.21 toolbox 945 reports various 802.21 MIH information, such as whether MIP is supported by various air interface technologies, via the MIH Information service to the MSCF 547 (step 968). The MSCF may then use the information collected to select the most preferred air interface technology and mobility service based, for example, on whether IMS is supported, whether there are alternative air interface technologies available, the type of air interface technologies available, the channel range, and so on. It is noted that the channel range may be used to indicate universal mobile access (UMA) services. The MSCF 547 then selects one or more mobility services and air interface technologies (step 970).

Purely for example, in the scenario depicted in signal flow diagram 900, the MSCF 547 determines that neither MIP nor IMS services are provided within the existing access network (that is, the E-UTRAN). The MSCF 547 identifies the existence of GAN mobility services by examining GERAN and UTRAN channel ranges and the existence of IEEE 802.21 and MIP mobility service support.

The MSCF 547 instructs the mobility services switch 942 to switch to a desired one of the plurality of mobility services 940 (step 972). The MSCF 547 instructs the access witch 952 to switch to a desired one of the plurality of air interface technologies 950 (step 974). It is noted that the order of activation of the selected mobility service and the selected air interface technology may change based on several factors including whether voice services are supported in the existing network, whether a more suitable mobility service is supported by another air interface technology, and the like. For example, even though both IMS and GAN services are available in a selected air interface technology, the MSCF 547 might chose to fall back to a UMTS based network supporting IMS functionality.

The mobility service switch 972, after receiving the instruction from the MSCF 547, switches to the selected mobility service (step 976). Similarly, the access switch 952, after receiving the instruction from the MSCF 547, switched to the selected air interface technology 950 and the associated radio access network. The voice service is continued using the selected air interface technology and mobility service (step 982).

Although the features and elements are described as embodiments in particular combinations, each feature or element can be used alone without the other features and elements of the embodiments or in various combinations with or without other features and elements. The methods presented may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A wireless transmit/receive unit comprising:
a multimode modem configured to communicate via a plurality of air interface technologies; and
a mobility subsystem comprising:
a plurality of mobility services; and
a processor configured to operate middleware comprising a mobility selection and control function (MSCF) configured to communicate with the plurality of air interface technologies, to select at least one of the plurality of air interface technologies, and to select at least one of the plurality of mobility services.

2. The WTRU of claim 1, wherein the plurality of air interface technologies include at least one of a wireless universal serial bus (W-USB) technology, a high rate packet data (HRPD) technology, a long term evolution (LTE) technology, a universal mobile telecommunication system (UMTS) terrestrial radio access network (UTRAN) technology, an IEEE 802 technology, and a global system for mobile communications (GSM) enhanced date rate for GSM evolution (EDGE) radio access network (GERAN) technology.

3. The WTRU of claim 1, wherein the plurality of mobility services include at least one of a session initiation protocol (SIP) service, an Internet protocol (IP) Multimedia subsystem (IMS) service, a voice call continuity (VCC) service, a mobile IP (MIP) service, a proxy MIP (PMIP) service, and a generic access network (GAN) service.

4. The WTRU of claim 1, further comprising:
an access switch in communication with the MSCF and the plurality of air interface technologies, and configured to select an air interface technology.

5. The WTRU of claim 1, further comprising:
a mobility service switch in communication between the MSCF and the plurality of mobility services, and configured to select a mobility service.

6. The WTRU of claim 1, wherein the multimode modem further comprises:
an IEEE 802.21 media independent handover (MIH) toolbox configured to provide MIH event, command, and information services to the MSCF.

7. The WTRU of claim 1, wherein the MSCF operates in an application layer of the WTRU.

8. The WTRU of claim 4, wherein the MSCF is further configured to transmit a message to the access switch including an indication of a selected one of the plurality of air interface technologies, and the access switch is further configured, in response to receipt of the message, to select the selected one of the plurality of air interface technologies.

9. The WTRU of claim 5, wherein the MSCF is further configured to transmit a message to the mobility service switch including an indication of a select one of the plurality of mobility services, and the mobility service switch is further configured, in response to receipt of the message, to select the selected on of the plurality of mobility services.

10. A method for use in a wireless transmit/receive unit (WTRU), the method comprising:
identifying a plurality of available mobility services;
identifying a plurality of available air interface technologies and associated access networks;
selecting one of the plurality of available mobility services and one of the plurality of available air interface technologies and associated access networks.

11. The method of claim 10, further comprising:
identifying at least one mobility service associated with a current air interface technology and associated access network;
identifying a plurality of mobility services associated with a plurality of neighboring air interface technologies and associated access networks; and
selecting a mobility service associated with the current air interface technology and associated access network, based on the identifies plurality of mobility services associated with the plurality of neighboring air interface technologies and associated access networks.

12. The method of claim 10, wherein the plurality of air interface technologies include at least one of a wireless universal serial bus (W-USB) technology, a high rate packet data (HRPD) technology, a long term evolution (LTE) technology, a universal mobile telecommunication system (UMTS) terrestrial radio access network (UTRAN) technology, an IEEE 802 technology, and a global system for mobile communications (GSM) enhanced date rate for GSM evolution (EDGE) radio access network (GERAN) technology.

13. The method of claim 10, wherein the plurality of mobility services include at least one of a session initiation protocol (SIP) service, an Internet protocol (IP) Multimedia subsystem (IMS) service, a voice call continuity (VCC) service, a mobile IP (MIP) service, a proxy MIP (PMIP) service, and a generic access network (GAN) service.

14. The method of claim 11, wherein the plurality of air interface technologies include at least one of a wireless universal serial bus (W-USB) technology, a high rate packet data (HRPD) technology, a long term evolution (LTE) technology, a universal mobile telecommunication system (UMTS) terrestrial radio access network (UTRAN) technology, an IEEE 802 technology, and a global system for mobile communications (GSM) enhanced date rate for GSM evolution (EDGE) radio access network (GERAN) technology.

15. The method of claim 11, wherein the plurality of mobility services include at least one of a session initiation protocol (SIP) service, an Internet protocol (IP) Multimedia subsystem (IMS) service, a voice call continuity (VCC) service, a mobile IP (MIP) service, a proxy MIP (PMIP) service, and a generic access network (GAN) service.
